(19) United States
(12) Patent Application Publication
(10) Pub. No.: US 2018/0031904 A1
(43) Pub. Date: Feb. 1, 2018

(54) ANGULAR FILTERS AND DISPLAY DEVICES COMPRISING THE SAME

(71) Applicant: CORNING INCORPORATED, CORNING, NY (US)

(72) Inventors: Charles Warren Lander, Wayland, NY (US); Li Liu, Painted Post, NY (US); Pamela Arlene Maurey, Savona, NY (US); Daniel Aloysius Nolan, Corning, NY (US); Wageesha Senaratne, Horseheads, NY (US)

(21) Appl. No.: 15/550,520

(22) PCT Filed: Feb. 11, 2016
(86) PCT No.: PCT/US16/17427

§ 371 Date: Aug. 11, 2017

Related U.S. Application Data
(60) Provisional application No. 62/115,765, filed on Feb. 13, 2015.

(51) Int. Cl. G02F 1/1335; C03B 17/06; G02B 26/00; G02B 5/20

(52) U.S. Cl. CPC G02F 1/133509; G02B 5/201; C03B 17/065; G02B 26/001

(57) ABSTRACT

Disclosed herein are light filters comprising a glass substrate having a surface patterned with a plurality of spaced apart rings, wherein each ring has an outer diameter independently ranging from about 10 microns to about 100 microns, and wherein the light filter has a haze of less than about 20%. Display devices comprises such light filters are also disclosed herein. Methods for making such light filters and methods for filtering light using such light filters are further disclosed herein.

### CROSS-REFERENCE TO RELATED APPLICATIONS

This application claims the benefit of priority under 35 U.S.C. § 119 of U.S. Provisional Application Ser. No. 62/115765 filed on Feb. 13, 2015, the content of which is relied upon and incorporated herein by reference in its entirety.

### FIELD OF THE DISCLOSURE

The disclosure relates generally to light filters and display devices comprising such filters, and more particularly to angular glass light filters and transparent display devices comprising the same.

### BACKGROUND

Liquid crystal displays (LCDs) are commonly used in various electronics, such as cell phones, laptops, electronic tablets, televisions, and computer monitors. There is a demand for higher contrast ratio, color gamut, and brightness in conventional LCDs while also balancing power requirements, e.g., in the case of handheld devices. Further, an emerging trend in electronics includes transparent displays which allow the user to the see device components or other objects behind the display panel. However, existing backlight technology may, at best, provide a distorted or inconsistent view of the objects behind the panel or may partially or completely block view of these objects, e.g., by casting a shadow.

Conventional light guide plates (LGPs) in transparent displays tend to emit light at angles that are more parallel to the plate. To enhance viewing, light emitted at an angle more normal to the plate may be preferable. Further, in conventional opaque displays, light from a LGP can be filtered using a variety of films for recycling parallel light and redirecting in a direction more normal to the plate. These films, however, are often hazy and cannot be used with transparent displays because they block the view of objects behind the display.

Accordingly, it would be advantageous to provide filters for transparent display devices which address one or more of the above drawbacks, e.g., filters that can redirect light in a direction more normal to the plate guide while also reducing haze and/or increasing transparency. In various embodiments, display devices (such as LCDs) comprising such backlights may be brighter, may have improved transparency, may have reduced haze, and/or may have improved viewing angles.

### SUMMARY

The disclosure relates, in various embodiments, to light filters comprising a glass substrate having a surface patterned with a plurality of spaced apart rings, wherein each ring has an outer diameter independently ranging from about 10 microns to about 100 microns, and wherein the light filter has a haze of less than about 20%. The disclosure also relates to substantially transparent light filters comprising a glass sheet having a surface patterned with a plurality of spaced apart rings comprising titania nanoparticles, wherein each ring has an outer diameter independently ranging from about 10 microns to about 100 microns. Display devices comprises such light filters are also disclosed herein. Such display devices can be substantially transparent and can comprise, e.g., a substantially transparent light guide plate.

In certain embodiments, the glass substrate can be a glass sheet having a thickness ranging from about 0.1 mm to about 3 mm. The glass sheet can comprise a glass chosen, for example, from aluminosilicate, alkali-aluminosilicate, borosilicate, alkali-borosilicate, aluminoborosilicate, and alkali-aluminoborosilicate glasses. According to various embodiments, the plurality of rings can comprise at least one inorganic material chosen from titania, zirconia, ceria, zinc oxide, alumina, silica, sapphire, diamond, galium arsenide, germania, and combinations thereof. In other embodiments, the plurality of rings can form an array of rings comprising a random or repeating pattern. The light filters can, in non-limiting embodiments, have a haze of less than about 5% and/or a transparency of at least about 90%.

Methods for making such light filters are also disclosed, the methods comprising depositing a plurality of spaced apart ink droplets on a surface of a glass substrate; and drying the ink droplets to form a plurality of spaced apart rings, wherein the ink droplets comprise at least one inorganic material chosen from titania, zirconia, ceria, zinc oxide, alumina, silica, sapphire, diamond, galium arsenide, germania, and combinations thereof, wherein each ring has an outer diameter independently ranging from about 10 microns to about 100 microns, and wherein the light filter has a haze of less than about 20%. Methods disclosed herein also include methods for filtering light by passing the light through the light filters disclosed herein.

According to various embodiments, the plurality of ink droplets may be deposited on the glass substrate by inkjet or micro-contact printing or microplotting. In some embodiments, the ink droplets further comprise at least one additional component chosen from solvents, surfactants, binders, and combinations thereof. The droplets may have a viscosity ranging, for instance, from about 1 cPs to about 40 cPs and/or a surface tension ranging from about 20 dynes/cm to about 40 dynes/cm.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 illustrates incident light scattering using an angular light filter according to embodiments of the disclosure;

FIG. 2 depicts a light filter comprising an array of rings;

FIG. 3 depicts a light filter comprising an array of rings having a random pattern;

FIG. 4 is a graphical depiction of angular light distribution from an etched light guide plate without a filter, with filters according to embodiments of the disclosure, and with a filter not in accordance with the disclosure; and

FIG. 5 illustrates a non-limiting display device having a light guide plate and filter according to certain embodiments.

### DETAILED DESCRIPTION

Disclosed herein are light filters comprising a glass substrate having a surface patterned with a plurality of spaced apart rings, wherein each ring has an outer diameter independently ranging from about 10 microns to about 100 microns, and wherein the light filter has a haze of less than about 20%. The disclosure also relates to substantially transparent light filters comprising a glass sheet having a surface patterned with a plurality of spaced apart rings comprising titania nanoparticles, wherein each ring has an outer diameter independently ranging from about 10 microns to about 100 microns. Display devices comprising such light filters are also disclosed herein.

Further disclosed herein are methods for making such light filters, the methods comprising depositing a plurality of spaced apart ink droplets on a surface of a glass substrate; and drying the ink droplets to form a plurality of spaced apart rings, wherein the ink droplets comprise at least one inorganic material chosen from titania, zirconia, ceria, zinc oxide, alumina, silica, sapphire, diamond, galium arsenide, germania, and combinations thereof, wherein each ring has an outer diameter independently ranging from about 100 microns to about 500 microns, and wherein the light filter has a haze of less than about 20%. Still further, the disclosure relates to methods for filtering light by passing the light through the light filters disclosed herein.

According to various embodiments, the light filters and/or glass substrates disclosed herein may be transparent or substantially transparent. As used herein, the term “transparent” is intended to denote that the glass substrate or light filter, at a thickness of approximately 1 mm, has a transmission of greater than about 70% in the visible region of the spectrum (400-700 nm). For instance, an exemplary transparent glass substrate or light filter may have greater than about 75% transmittance in the visible light range, such as greater than about 80%, greater than about 85%, greater than about 90%, greater than about 92%, greater than about 95%, or greater than about 99% transmittance, including all ranges and subranges therebetween. According to various embodiments, the glass substrate or light filter may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary glass substrate or light filter may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 92%, greater than about 95%, or greater than about 99% transmittance, including all ranges and subranges therebetween.

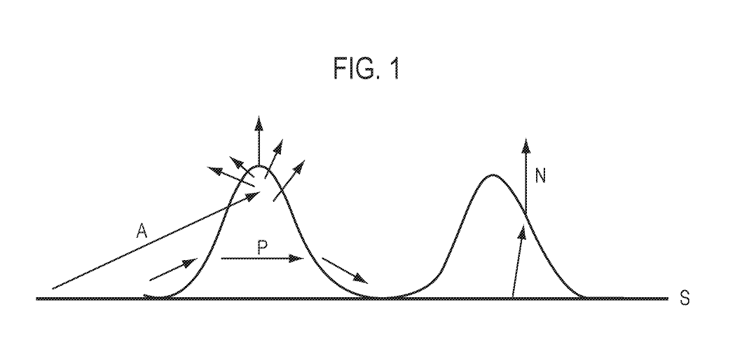

According to additional embodiments, the light filters disclosed herein may have a low haze. Haze can result from the diffusion of light in all directions which can, in turn, result in a loss of contrast. As used herein, “haze” is referred to as the percentage of light which deviates from the incident beam at an angle greater than 2.5 degrees on average when passing through a substrate (ASTM D 1003). FIG. 1 illustrates a general principle of operation of various embodiments of the disclosure with respect to incident light scattering. The angular filters disclosed herein can backscatter high angle light A, while recycling light P having angles more parallel to the substrate S to produce light N that is more normal to the substrate S. An exemplary light filter as disclosed herein may have less than about 20% haze, such as less than about 19%, 18%, 17%, 16%, 15%, 14%, 13%, 12%, 11%, 10%, 9%, 8%, 7%, 6%, 5%, 4%, 3%, 2%, 1%, 0.5%, or 0.1%, including all ranges and subranges therebetween.

The glass substrate may comprise any glass known in the art for use as a light filter including, but not limited to, aluminosilicate, alkali-aluminosilicate, borosilicate, alkali-borosilicate, aluminoborosilicate, alkali-aluminoborosilicate, and other suitable glasses. In certain embodiments, the glass substrate may have a thickness of less than or equal to about 3 mm, for example, ranging from about 0.1 mm to about 2.5 mm, from about 0.3 mm to about 2 mm, from about 0.7 mm to about 1.5 mm, or from about 1 mm to about 1.2 mm, including all ranges and subranges therebetween. Non-limiting examples of commercially available glasses suitable for use as a light filter include, for instance, EAGLE XG®, Lotus™, Willow®, and Gorilla® glasses from Corning Incorporated. In additional embodiments, the glass substrate can comprise high transmission glass and/or low-Fe glass such as, but not limited to, Iris™ glasses from Corning Incorporated.

The glass substrate can comprise a glass sheet having a first surface and an opposing second surface. The surfaces may, in certain embodiments, be planar or substantially planar, e.g., substantially flat and/or level. The glass substrate can also, in some embodiments, be curved about at least one radius of curvature, e.g., a three-dimensional glass substrate, such as a convex or concave substrate. The first and second surfaces may, in various embodiments, be parallel or substantially parallel. The glass substrate may further comprise at least one edge, for instance, at least two edges, at least three edges, or at least four edges. By way of a non-limiting example, the light filter may comprise a rectangular or square glass sheet having four edges, although other shapes and configurations are envisioned and are intended to fall within the scope of the disclosure. According to various embodiments, the glass substrate may have a refractive index ranging from about 1.3 to about 1.7, such as from about 1.4 to about 1.6, including all ranges and subranges therebetween.

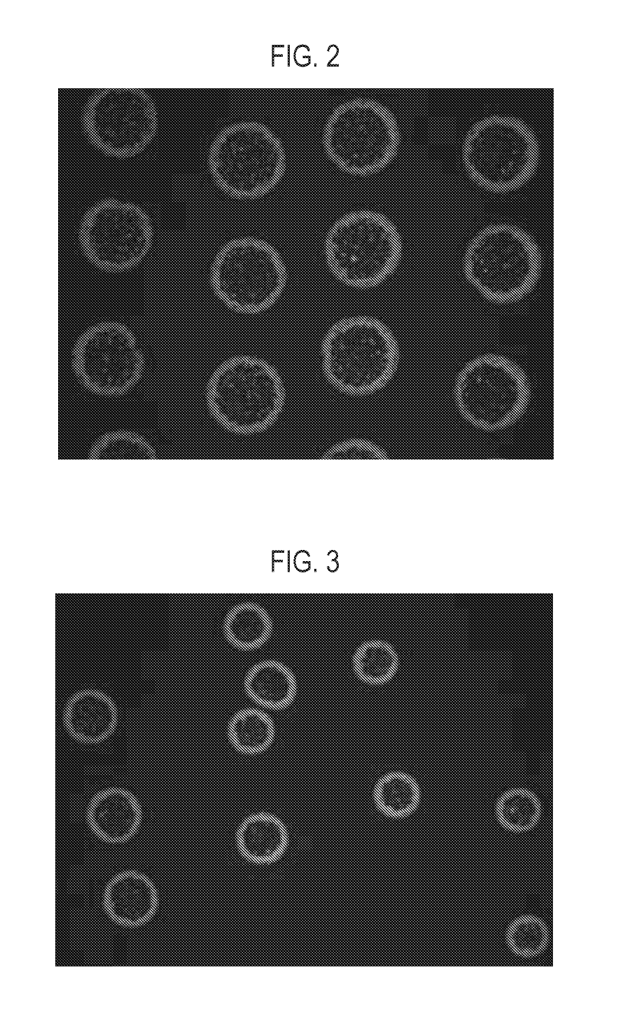

In non-limiting embodiments, the first and/or second surface of the light filter may be patterned with a plurality or an array of rings. As used herein, the term “patterned” is intended to denote that the rings are present on the surface of the light filter in any given pattern or design, which may, for example, be random or arranged (ordered), repetitive or non-repetitive. The pattern may also be semi-ordered or semi-repetitive. FIG. 2 illustrates a light filter comprising an array of rings according to various embodiments of the disclosure, which is somewhat (semi), although not perfectly, ordered and repetitive. FIG. 3 illustrates a light filter comprising an array of rings according to other embodiments of the disclosure, which is completely random and non-repetitive. Without wishing to be bound by theory, it is believed that a random and non-repetitive pattern can result in a more transparent filter as compared to a filter having an ordered and/or repetitive pattern. In certain embodiments, as shown in FIGS. 2-3, the rings may be annuli or coffee rings (also described as the “coffee ring effect”). In further embodiments, the rings can be substantially round or circular. The rings may be deposited, coated, printed, or otherwise provided on the glass substrate. According to various embodiments, the plurality of rings may be printed onto the glass substrate using any technique suitable for dispensing droplets having a volume ranging from less than one picoliter up to 100 picoliters or greater, such as from about 1 pL to about 100 pL, from about 5 pL to about 75 pL, from about 10 pL to about 60 pL, or from about 25 pL to about 50 pL, including all ranges and subranges therebetween. Suitable techniques can employ, for example, inkjet printers, micro-contact printers, microplotters, and other similar devices. Additional details regarding the printing methods are provided below with respect to the methods for making the filters disclosed herein.

The plurality of rings may be defined by one or more parameters, such as overall diameter, void diameter, ring thickness, ring height, and distance between rings, to name a few. In various embodiments, each ring may have an overall diameter (distance from outer ring edge to opposite outer ring edge) of up to about 100 microns, such as ranging from about 10 microns to about 100 microns, from about 20 microns to about 90 microns, from 30 microns to about 80 microns, from 40 microns to about 70 microns, or from about 50 microns to about 60 microns, including all ranges and subranges therebetween. The void diameter (distance from inner ring edge to opposite inner ring edge) can range up to about 99 microns, such as from about 5 microns to about 90 microns, from about 10 microns to about 80 microns, from about 20 microns to about 70 microns, from about 30 microns to about 60 microns, or from about 40 microns to about 50 microns, including all ranges and subranges therebetween. The thickness of the ring (overall diameter minus void diameter) can, for example, be less than about 50 microns, such as less than about 40 microns, less than about 25 microns, less than about 10 microns, less than about 5 microns, or less than about 1 micron, including all ranges and subranges therebetween.

The ring height (thickness of deposited layer) can be, for example, less than about 20 microns, such as less than about 15 microns, less than about 10 microns, less than about 5 microns, less than about 4 microns, less than about 2 microns, or less than about 1 micron, including all ranges and subranges therebetween. In some embodiments, the ring height can be less than 500 nm, less than 100 nm, or less than about 50 nm, including all ranges and subranges therebetween. According to various embodiments, the ring height can range, for example, from about 0.5% to about 50% of the value of the outer ring diameter, such as from about 1% to about 25% of the outer ring diameter, or from about 5% to about 10% of the outer ring diameter, including all ranges and subranges therebetween.

The distance between rings (distance from outer edge of one ring to outer edge of another ring) can vary depending on the pattern (regular or random), and can range, for instance, from about 25 microns to about 5000 microns, such as from about 50 microns to about 3000 microns, from about 100 microns to about 2500 microns, from about 200 microns to about 2000 microns, from 300 microns to about 1500 microns, or from about 500 microns to about 1000 microns, including all ranges and subranges therebetween. As used herein the term “spaced apart” is intended to denote that the rings (or droplets as printed) in the plurality or array of rings are not touching or abutting one another, e.g., have space between them. Of course, it is to be understood that the above parameters can vary from ring to ring within the plurality or array and are not intended to be limiting on the appended claims.

The plurality of rings can comprise any material with a relatively high refractive index suitable for use in a light filter. For example, the rings can comprise a material with a refractive index of at least about 1.5, such as at least about 1.7, at least about 2, at least about 2.5, at least about 3, or at least about 4 (e.g., 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4), including all ranges and subranges therebetween. In some embodiments, the material can be an inorganic material selected from metal oxides, such as transition metal oxides. Exemplary metal oxides include, but are not limited to, titania, zirconia, ceria, zinc oxide, alumina, silica, germania, and combinations thereof. Other non-limiting exemplary materials can include, for instance, sapphire, diamond, silver, gold, platinum, galium arsenide, or other similar high-index materials, and combinations thereof. In certain embodiments, all rings in the plurality or array can comprise the same material. Of course, all rings in the plurality or array need not comprise the same material and the appended claims are not so limited.

The void (inner portion of the ring) can be free of the material making up the ring, or substantially free of the material. For example, the void can comprise less than about 10%, less than about 5%, less than about 3%, less than about 2%, less than about 1%, or 0% of the material relative to the total amount of material present in the ring. In non-limiting embodiments, the ring material can cover at least about 5% of the glass surface, such as at least about 10%, at least about 15%, at least about 20%, at least about 25%, at least about 30%, at least about 35%, at least about 40%, at least about 45%, at least about 50%, at least about 55%, or greater, including all ranges and subranges therebetween. In additional embodiments, the ring material can cover less than about 95% of the glass surface, such as less than about 90%, less than about 85%, less than about 80%, less than about 75%, less than about 70%, less than about 65%, less than about 60%, less than about 55%, less than about 50%, or less than about 45%, including all ranges and subranges therebetween. Portions of the glass not covered or not substantially covered by the material (e.g., ring voids+spaces between rings) can be referred to as “open space” and can make up, for example, from about 5% to about 95% of the total glass surface, such as from about 10% to about 90%, from about 25% to about 85%, from about 30% to about 80%, from about 35% to about 70%, from about 40% to about 60%, or from about 50% to about 55%, including all ranges and subranges therebetween.

According to various embodiments, the material can be in the form of nanoparticles, e.g., particles having an average particle size of less than 1 micron, such as less than 500 nm, less than 250 nm, less than 100 nm, less than 50 nm, or less than 10 nm, including all ranges and subranges therebetween. The rings can comprise, in certain embodiments, agglomerates of such nanoparticles. In certain embodiments, the material can be conductive, non-conductive, or semi-conductive. In at least one non-limiting embodiment, the filter is non-conductive. According to other embodiments, the filter is semi-conductive. In yet further embodiments, the material can be transparent or substantially colorless or transparent and the light filter can likewise be transparent or substantially transparent.

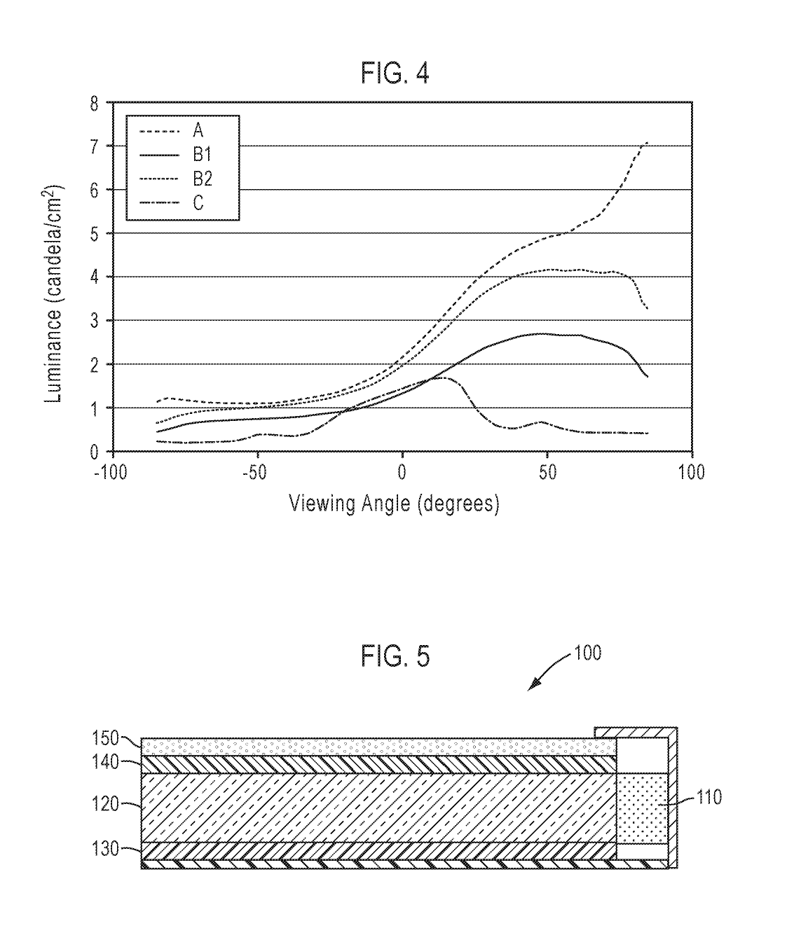

FIG. 4 illustrates the angular distribution of light emitted from an etched LGP without a filter (plot A), as well as that of light emitted from the same LGP with a light filter according to various embodiments of the disclosure (plots B1: FIGS. 3 and B2: FIG. 2). For comparative purposes, the angular distribution of light emitted from the LGP equipped with a Vikuiti™ brightness enhancing film (BEF) from 3M is also illustrated (plot C). Filter B1 has a 4% haze and is 91% transparent, whereas filter B2 has a 15% haze and is 88% transparent. By comparison, the haze of filter C is 100%. Thus, according to various embodiments, the filters disclosed herein can provide a luminance greater than about 1 candela/cm² for viewing angles ranging from about 45-90°, such as greater than about 1.5 candelas/cm², greater than about 2 candelas/cm², 2.5 candelas/cm², greater than about 3 candelas/cm², greater than about 3.5 candelas/cm², or greater than about 4 candelas/cm². For head-on viewing (viewing angle of approximately 90°), the light filters disclosed herein can provide a luminance ranging from about 1 to about 4 candelas/cm², such as from about 2 to about 3 candelas/cm², including all ranges and subranges therebetween.

Accordingly, at viewing angles ranging from about 45-90°, the filters of the instant disclosure can provide at least about 50% of the original luminance (e.g., luminance from a glass substrate without a filter), such as at least about 60%, at least about 70%, at least about 80%, or at least about 90% of the original luminance. In contrast, the prior art filter provides less than 1 candela/cm² for viewing angle ranging from about 45-90° and, for head-on viewing, the luminance is even less than 0.5 candela/cm². Thus, prior art filters may provide less than about 25% of the original luminance, or even less than about 10% of the original luminance at viewing angles ranging from about 45-90°.

Angular filters as disclosed herein can be produced by depositing a plurality of spaced apart ink droplets on a surface of a glass substrate and drying the ink droplets to form a plurality of spaced apart rings. The droplets may be deposited on the glass substrate surface using the printing processes disclosed herein, e.g., inkjet printing, micro-contact printing, and microplotting. The droplets can have, for example, a volume in the picoliter to microliter range, as necessary to form rings having the desired shape and size. According to certain embodiments, the volume of the droplets can range from less than about one picoliter to 100 picoliters or greater, such as from about 1 pL to about 100 pL, from about 5 pL to about 75 pL, from about 10 pL to about 60 pL, or from about 25 pL to about 50 pL, including all ranges and subranges therebetween. The viscosity of the ink can be chosen to produce the desired ring shape and size, e.g., to achieve a coffee ring effect, by balancing the ink's fluid properties with the surface tension of the droplet. In various embodiments, the viscosity of the ink can range from about 1 cPs to about 40 cPs, such as from about 5 cPs to about 30 cPs, from about 10 cPs to about 25 cPs, or from about 15 cPs to about 20 cPs, including all ranges and subranges therebetween. The surface tension of the droplets formed from the ink can range, in some embodiments, from about 20 dynes/cm to about 40 dynes/cm, such as from about 25 dynes/cm to about 36 dynes/cm, or from about 28 dynes/cm to about 30 dynes/cm, including all ranges and subranges therebetween.

The ink can comprise various materials disclosed herein with reference to the makeup of the rings, such as inorganic materials, e.g., metal oxides. The ink can further comprise additional components, such as solvents, surfactants, binders, and combinations thereof. Suitable solvents can include, for example, aliphatic alcohols, aromatic hydrocarbons, glycols, glycol ethers, lactates and esters, aliphatic and aromatic ketones, polyethyleneglycols, polypropylene glycols, water, and combinations thereof. In various embodiments, the ink can comprise from about 5% to about 95% by weight of inorganic materials, such as from about 10% to about 80% by weight, from about 15% to about 70%, from about 20% to about 60% by weight, from about 25% to about 50%, or from about 30% to about 40% by weight, including all ranges and subranges therebetween.

After depositing the droplets on the glass substrate, the droplets can be dried to produce rings as desired using any suitable drying method known in the art. For instance, the droplets may be allowed to air dry at ambient temperature and pressure, or may be dried using heat. In certain embodiments, the glass substrate may be heated to a temperature ranging from about 25° C. to about 100° C. to dry the droplets and produce the plurality of rings, such as from about 30° C. to about 75° C., or from about 50° C. to about 60° C., including all ranges and subranges therebetween. The drying time can range, for example, from about 1 minute to about 1 hour, such as from about 5 minutes to about 45 minutes, from about 10 minutes to about 30 minutes, or from about 15 minutes to about 20 minutes, including all ranges and subranges therebetween. Of course other drying methods, temperatures, and times can be used and are envisioned as falling within the scope of the disclosure.

The light filters disclosed herein may be used in various display devices including, but not limited to, LCDs. FIG. 5 illustrates a non-limiting display device having a light filter according to some embodiments of the disclosure. With reference to FIG. 5, a display device 100 can comprise a light source 110, for example, light-emitting diodes (LEDs) or cold cathode fluorescent lamps (CCFLs). Conventional LCDs may employ LEDs or CCFLs packaged with color converting phosphors to produce white light. The device 100 may further comprise a light guide plate 120, through which the light can travel and be redirected toward the LCD. A reflector film 130 can be used to send recycled light back through the light guide plate 120. Light from the light guide plate 120 can then pass through light filter 140, which can backscatter high angle light and reflect low angle light back toward the reflector film 130 for recycling and may serve to concentrate light in the forward direction (e.g., toward the user). A liquid crystal layer 150 may comprise an electrooptic material, the structure of which rotates upon application of an electric field, causing a polarization rotation of any light passing through it. Other optical components can include, e.g., prism films, polarizers, or TFT arrays, to name a few. According to various embodiments, the angular light filters disclosed herein can be paired with a transparent light guide plate in a transparent display device.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a ring” includes examples having two or more such rings unless the context clearly indicates otherwise. Likewise, a “plurality” or an “array” is intended to denote “more than one.” As such, a “plurality of droplets” includes two or more such droplets, such as three or more such droplets, etc., and an “array of rings” comprises two or more such rings, such as three or more such rings, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A light filter comprising a glass substrate having a surface patterned with a plurality of spaced apart rings, wherein each ring has an outer diameter independently ranging from about 10 microns to about 100 microns, and wherein the light filter has a haze of less than about 20%.

2. The light filter of claim 1, wherein the glass substrate is a glass sheet having a thickness ranging from about 0.1 mm to about 3 mm.

3. The light filter of claim 1, wherein the glass substrate comprises a glass chosen from aluminosilicate, alkali-aluminosilicate, borosilicate, alkali-borosilicate, aluminoborosilicate, and alkali-aluminoborosilicate glasses.

4. The light filter of claim 1, wherein the plurality of spaced apart rings form an array comprising a repeating or random pattern of rings.

5. The light filter of claim 1, wherein each ring comprises at least one inorganic material independently chosen from titania, zirconia, ceria, zinc oxide, alumina, silica, sapphire, diamond, galium arsenide, germania, and combinations thereof.

6. The light filter of claim 1, wherein each ring has a void diameter independently ranging from about 10 microns to about 99 microns.

7. The light filter of claim 1, having a haze of less than about 10%.

8. The light filter of claim 1, having a transparency of at least about 90%.

9. The light filter of claim 1, wherein about 10% to about 75% of the area of the surface of the glass substrate is patterned by the plurality of spaced apart rings.

10. A display device comprising the light filter of claim 1.

11. The display device according to claim 10, further comprising a substantially transparent light guide plate.

12. The display device according to claim 11, wherein an overall luminance of the light filter and the transparent light guide plate is at least about 50% of a luminance of the transparent light guide plate.

13. A method for making a light filter comprising:
depositing a plurality of spaced apart ink droplets on a surface of a glass substrate;
drying the ink droplets to form a plurality of spaced apart rings,
wherein the ink droplets comprise at least one inorganic material chosen from titania, zirconia, ceria, zinc oxide, alumina, silica, sapphire, diamond, galium arsenide, germania, and combinations thereof,
wherein each ring has an outer diameter independently ranging from about 100 microns to about 500 microns, and
wherein the light filter has a haze of less than about 10%.

14. The method of claim 13, wherein depositing the plurality of spaced apart ink droplets comprises inkjet printing, micro-contact printing, or microplotting techniques.

15. The method of claim 13, wherein the ink further comprises at least one solvent chosen from aliphatic alcohols, aromatic hydrocarbons, glycols, glycol ethers, lactates and esters, aliphatic and aromatic ketones, polyethyleneglycols, polypropylene glycols, water, and combinations thereof.

16. The method of claim 13, wherein the ink droplets has a viscosity ranging from about 1 cPs to about 20 cPs and a surface tension ranging from about 20 dynes/cm to about 40 dynes/cm.

17. The method of claim 13, wherein each ring has a void diameter independently ranging from about 50 microns to about 300 microns.

18. The method of claim 13, wherein the glass substrate is a substantially transparent glass sheet.

19. The method of claim 13, wherein the plurality of spaced apart rings for an array comprising a repeating or random pattern of rings.

20. A substantially transparent light filter comprising a glass sheet having a surface patterned with a plurality of spaced apart rings comprising titania nanoparticles, wherein each ring has an outer diameter independently ranging from about 10 microns to about 100 microns.

21. The light filter of claim 20, having a haze of less than about 20%.
